(19) United States
(12) Patent Application Publication
(10) Pub. No.: US 2008/0240112 A1
(43) Pub. Date: Oct. 2, 2008

(54) LAYER 2 ROUTING PROTOCOL

(76) Inventors: ALAA MUQATTASH, San Diego, CA (US); Ghobad Heidari-Bateni, San Diego, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 12/059,941

(22) Filed: Mar. 31, 2008

Related U.S. Application Data
(60) Provisional application No. 60/908,881, filed on Mar. 29, 2007.

(51) Int. Cl. H04L 12/28

(52) U.S. Cl. 370/395.31

(57) ABSTRACT

A layer 2 routing protocol that may route packets from a source to a destination via intermediate devices is proposed. In some embodiments, the proposed routing scheme may be a variant of the AODV routing protocol that runs at layer 2. The routing may be transparent to upper layers (e.g., the IP layer), so no modifications whatsoever to upper layers are needed to enable multi-hop communication for WiMedia-based devices. The proposed scheme may take advantage of the information (e.g., detailed channel condition) and tools (e.g., beacon protocol) available at WiMedia MAC to reduce the overhead needed to exchange routing messages. The proposed scheme may also support end-to-end quality-of-service allowing applications to find and reserve resources along a route in a distributed manner.

### CROSS-REFERENCE TO RELATED APPLICATIONS

This application claims priority to U.S. Provisional Patent Application No. 60/908,881, filed Mar. 29, 2007, the contents of which is incorporated herein by reference in its entirety.

### TECHNICAL FIELD

The present invention relates generally to wireless communication, and more particularly, some embodiments relate to routing protocols.

### DESCRIPTION OF THE RELATED ART

The term wireless network generally refers to a telecommunications network whose interconnections between nodes are implemented without the use of wires. Example wireless networks may include, for example, networks implemented using the WiMedia Ultra-Wideband (“UWB”) standards. Other examples include BlueTooth®, and the Institute of Electrical and Electronic Engineers (“IEEE”) 802.11 standard, to name just a few. A wireless network might include almost any type of communication system that is wireless. For example, wireless telecommunications networks are generally implemented with some type of information transmission system that uses electromagnetic waves. Many wireless networks use systems that transmit and receive over radio waves, infrared, or other types of electromagnetic waves.

Many networks, including many wireless networks can be characterized using the seven-layer Open System Interconnection Basic Reference Model (“OSI Reference Model” or “OSI Model” for short). The OSI model is broken into seven different “layers” or “levels.” Layer 1 is known as the physical layer. It is the most basic network layer. The physical layer may provide only the means of transmitting raw bits rather than packets over a physical data link connecting network nodes. Layer 2 is known as the data link layer. The data link layer provides the functional and procedural means to transfer data between network entities. Additionally, the data link layer might provide functionality that detects and possibly corrects errors that may occur in the physical layer. One part of the data link layer is the Medium Access Control (“MAC”). The MAC provides addressing and channel access control mechanisms. These mechanisms allow several terminals or network nodes to communicate within a multipoint network. Layer 3 is known as the network layer. The network layer is responsible for source to destination packet delivery. Other layers include, layer 4, the transport layer; layer 5, the session layer; layer 6, the presentation layer; and layer 7, the application layer. The OSI model is well know by those of skill in the art and, for brevity, layers 4-7 will not be discussed herein.

In one example wireless network, a WiMedia platform might include a device that has a WiMedia MAC and a WiMedia physical layer. As discussed, the MAC is a data communication protocol sub-layer that is part of the seven-layer OSI Model. The MAC provides addressing and channel access control that allows multiple terminals or nodes to communicate within a multipoint network. Additionally, as discussed above, the physical layer is the first layer in the OSI model. The physical layer is the most basic network. It allows the transmitting of raw bits rather than packets over a physical data link connecting network nodes.

A WiMedia platform might generally only communicate with devices that are within range. The relatively short range of a WiMedia platform might be extended using multi-hop communication. For example, a source device might communicate with a destination device by transmitting to an intermediate device. The intermediate device might then transmit the data to the destination device. To extend the range of a WiMedia device using multi-hop communication, a routing protocol is useful to route packets from a source to a destination via multiple intermediate devices.

Traditional wire-based IP routing protocols might have disadvantages because these protocols might have a great deal of overhead and be designed based on wired assumptions that simply do not apply to wireless communication devices.

Network layer (layer 3) approaches might be used to allow communication between devices that are not in range of each other directly. Examples of such layer 3 approaches include: multi-hop ad hoc routing protocols such as Dynamic Source Routing (“DSR”), Temporally-Ordered Routing Algorithm (“TORA”), Ad-hoc On-demand Distance Vector (“AODV”), etc. DSR is a routing protocol for wireless mesh networks. It uses source routing to form a route on-demand when a transmitting computer requests one instead of relying on the routing table at each intermediate device. The TORA routing algorithm is an algorithm for routing data across Wireless Mesh Networks or Mobile ad-hoc networks. The AODV routing algorithm is an algorithm for routing data across wireless mesh networks that is capable of both unicast and multicast routing. Using a layer 3 approaches such as DSR, TORA, ADVO, etc. might require layer 3 changes, which may be unpopular due to the large number of preexisting devices.

### BRIEF SUMMARY OF EMBODIMENTS OF THE INVENTION

According to various embodiments of the invention, a routing protocol that operates at layer 2 (i.e., the MAC layer) is proposed. A routing protocol that operates at layer 2 might be transparent to the upper layer (e.g., the IP layer). Accordingly, in some embodiments no modifications to the upper layer are required to enable multi-hop communication for WiMedia-based devices. At layer 3 of a device, devices that are several hops away might appear as “neighbors,” for example, on the same segment, for example, as if they are all on the same Ethernet. Additionally, because the solution operates at layer 2, the proposed scheme, in various embodiments, might take advantage of information and tools such as detailed channel condition and beacon protocol that may be available at layer 2. This might be done to reduce the overhead needed to exchange routing messages or to choose routes that might offer increased performance under certain circumstances.

Bridges or routers might be used to forward data packets using MAC or IP addresses, respectively. Performing routing at the MAC layer using bridges might have the disadvantage that packets are sent over a spanning tree to avoid looping of packets. This means that packets may be sent over paths that are longer than the shortest paths between a pair of devices. Accordingly, the available bandwidth may be underutilized. Furthermore, in an ad hoc network, maintaining a spanning tree might incur excessive overhead depending on mobility. On the other hand, performing routing at layer 3, e.g., using the next hop IP address to route the packet, is not transparent to IP but instead, requires some changes at layer 3. Changes to the IP protocol might require upgrading of millions of already existing devices. In various embodiments, the proposed approach consists of modifications introduced on already existing layer 3 routing protocols (e.g., AODV, TORA, DSR). How information is exchanged might be revised to take advantage of the information and tools available at layer 2 in order to reduce the overhead needed to exchange routing messages and to choose routes that might offer higher performance under certain circumstances.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a block diagram illustrating one possible configuration of a wireless network that might serve as an example environment in which the present invention might be implemented.

FIG. 2 is a diagram illustrating an example actual topology including four devices.

FIG. 3 is a diagram illustrating an example perceived topology including four devices.

FIGS. 4-10 are diagrams illustrating examples of how a table might be built.

FIG. 11A-B is a flowchart illustrating one example method of building a routing table in accordance with FIGS. 4-10.

The figures are not intended to be exhaustive or to limit the invention to the precise form disclosed. It should be understood that the invention might be practiced with modification and alteration and that the invention be limited only by the claims and the equivalents thereof.

### DETAILED DESCRIPTION OF THE EMBODIMENTS OF THE INVENTION

Various embodiments of the invention provide a routing protocol that operates at layer 2. Such a routing protocol might be transparent to the upper layer. Accordingly, in some embodiments, no modifications to the upper layer are required to enable multi-hop communication for WiMedia-based devices. In other embodiments, at layer 3 of a device, devices that are several hops away will appear as “neighbors.” For example, the devices may appear to be on the same segment as if they are all on the same Ethernet. Additionally, because the solution operates at layer 2, the proposed scheme, in some embodiments, might take advantage of the information and tools such as detailed channel condition or beacon protocol which may be available at layer 2 to reduce the overhead needed to exchange routing messages and to choose routes that might offer increased performance under certain circumstances.

Before describing the invention in detail, it is useful to describe an example environment in which the invention might be implemented. One such example is a wireless network in which multiple electronic devices (for example, computers and computing devices, cellular telephones, personal digital assistants, motion and still cameras, among others) might communicate and share data, content and other information with one another. From time-to-time, the present invention is described herein in terms of a network of multiple devices such as a wireless USB connection. Description in terms of this environment is provided to allow the various features and embodiments of the invention to be portrayed in the context of an exemplary application. After reading this description, it will become apparent to one of ordinary skill in the art how the invention might be implemented in different and alternative environments. Indeed, applicability of the invention is not limited to a wireless USB connection. The systems and methods described herein might be applied to other wireless standards, such as Bluetooth, Wibree, WirelessHD, ZigBee, Cypress Semiconductor “WirelessUSB,” and other wireless standards.

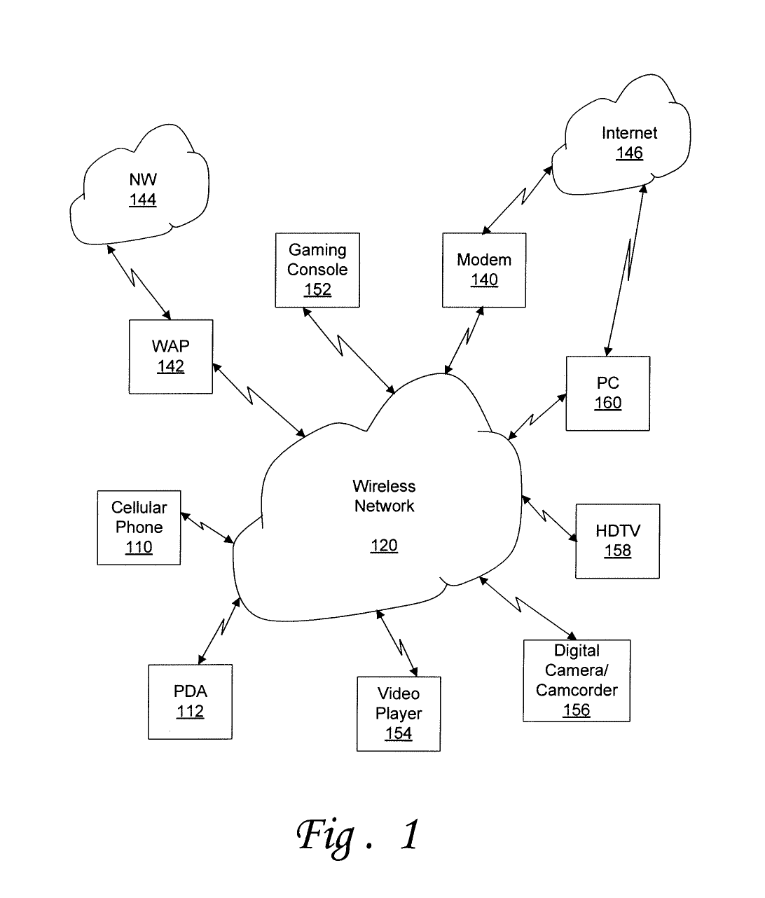

FIG. 1 is a block diagram illustrating one possible configuration of a wireless network that might serve as an example environment in which the present invention may be implemented. Referring now to FIG. 1, a wireless network 120 is provided to allow a plurality of electronic devices to communicate with one another without the need for wires or cables between the devices. A wireless network 120 might vary in coverage area depending on a number of factors or parameters including, for example, the transmit power levels and receive sensitivities of the various electronic devices associated with the network. Examples of wireless networks might include the various IEEE and other standards as described above, as well as other wireless network implementations. The wireless network 120 might be, for example, a wireless USB connection, a Bluetooth connection, a Wibree connection, a WirelessHD connection, a ZigBee connection, a Cypress Semiconductor “WirelessUSB” connection, or other wireless connection.

With many applications, the wireless network 120 may operate in a relatively confined area, such as, for example, a home or an office. The example illustrated in FIG. 1 is an example of an implementation such as that which might be found in a home or small office environment. Of course wireless communication networks and communication networks in general are found in many environments outside the home and office as well. In the example illustrated in FIG. 1, wireless network 120 includes a communication device to allow it to communicate with external networks. More particularly, in the illustrated example, wireless network 120 includes a modem 140 to provide connectivity to an external network such as the Internet 146, and a wireless access point 142 that might provide external connectivity to another network 144.

Also illustrated in the example wireless network 120 are portable electronic devices such as a cellular telephone 110 and a personal digital assistant (“PDA”) 112. Like the other electronic devices illustrated in FIG. 1, cellular telephone 110 and PDA 112 might communicate with wireless network 120 via the appropriate wireless interface. Additionally, these devices might be configured to further communicate with an external network. For example, cellular telephone 110 is typically configured to communicate with a wide area wireless network by way of a base station.

Additionally, the example environment illustrated in FIG. 1 also includes examples of home entertainment devices connected to wireless network 120. In the illustrated example, electronic devices such as a gaming console 152, a video player 154, a digital camera/camcorder 156, and a high definition television 158 are illustrated as being interconnected via wireless network 120. For example, a digital camera or camcorder 156 might be utilized by a user to capture one or more still picture or motion video images. The captured images might be stored in a local memory or storage device associated with digital camera or camcorder 156 and ultimately communicated to another electronic device via wireless network 120. For example, the user might wish to provide a digital video stream to a high definition television set 158 associated with wireless network 120. As another example, the user might wish to upload one or more images from digital camera 156 to his or her personal computer 160 or to the Internet 146. This might be accomplished by wireless network 120. Of course, wireless network 120 might be utilized to provide data, content, and other information sharing on a peer-to-peer or other basis, as the provided examples serve to illustrate.

Also illustrated is a personal computer 160 or other computing device connected to wireless network 120 via a wireless air interface. As depicted in the illustrated example, personal computer 160 might also provide connectivity to an external network such as the Internet 146.

In the illustrated example, wireless network 120 is implemented so as to provide wireless connectivity to the various electronic devices associated therewith. Wireless network 120 allows these devices to share data, content, and other information with one another across wireless network 120. Typically, in such an environment, the electronic devices would have the appropriate transmitter, receiver, or transceiver to allow communication via the air interface with other devices associated with wireless network 120. These electronic devices might conform to one or more appropriate wireless standards and, in fact, multiple standards might be in play within a given neighborhood. Electronic devices associated with the network typically also have control logic configured to manage communications across the network and to manage the operational functionality of the electronic device. Such control logic might be implemented using hardware, software, or a combination thereof. For example, one or more processors, ASICs, PLAs, and other logic devices or components might be included with the device to implement the desired features and functionality. Additionally, memory or other data and information storage capacity might be included to facilitate operation of the device and communication across the network.

Electronic devices operating as a part of wireless network 120 are sometimes referred to herein as network devices, members or member devices of the network or devices associated with the network. In some embodiments, devices that communicate with a given network might be members or merely in communication with the network.

Generally, in a wireless USB connection one device might be referred to as a wireless USB host, or just “host”; while another might be referred to as a wireless USB device, an “external device,” a “client” or just a “device.” A wireless USB device might be, for example, any device that might be connected to a computer or other device, such as a printers, cameras, camcorders, PDA's, cellular telephones, video players, HDTV's, modems, keyboards, mice, etc. This list is not intended to be exhaustive. A wireless USB host might be any device that might be connected to a USB device. For example, a computer might be a wireless USB host. It will be understood, however, that devices, such as cellular phones, might be a wireless USB host in some cases. When referring to both a wireless USB host and a wireless USB device the term “devices” might be used. The term “client” is intended to differentiate a wireless USB device from a wireless USB host. In general a client will be physically external, i.e., not inside of a wireless USB host, however, a client is not limited to wireless USB devices that are external to the wireless USB host.

Several examples of the systems and methods described herein are illustrated using examples that include wireless USB communication. It will be understood that the systems and methods described herein might be used in conjunction with other wireless communication standards. Thus, the terms “host,” “external device,” “device,” “devices,” etc. might refer to devices, systems, or components that implement these other wireless communication standards. Thus, for example, the term “host” might be used to described a computer that uses, for example, the Bluetooth standard to communicate with a client such as a mobile telephone, PDA, external hard drive, etc.

In various embodiments, a WiMedia platform might communicate only with devices that are within range. A WiMedia platform might include a device that has a WiMedia Medium Access Control (“MAC”) and a WiMedia physical layer. To extend the relatively short range of a WiMedia device using multi-hop communication, a routing protocol might be used to route packets from a source to a destination. This routing of packets might be via multiple intermediate devices, for example. In some embodiments, a routing protocol that operates at layer 2 (i.e., the MAC layer) might be used. A routing protocol that operates at layer 2 may be transparent to upper layers, such as, for example, the Internet Protocol (“IP”) layer. In this way modifications to the upper layer might be avoided while still allowing multiple hop communication for WiMedia-based devices. In some embodiments, for layer 3 of a device, devices that are several hops away might appear as “neighbors.” For example, the devices may appear to be on the same segment (e.g., as if they are all on the same Ethernet).

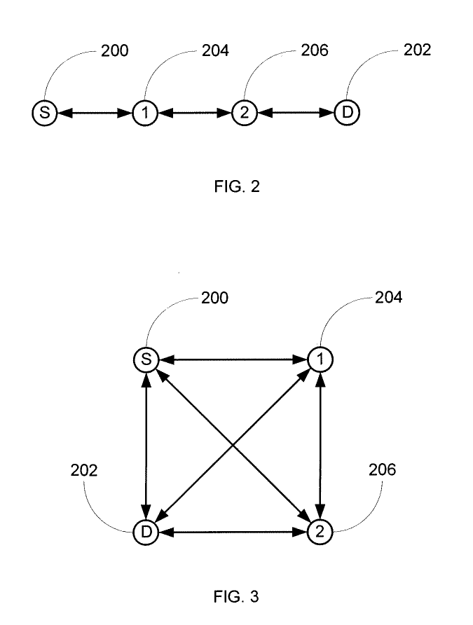

For example, FIG. 2 is a diagram illustrating an example of one possible actual topology between a source device 200 and a destination device 202. Referring to FIG. 2, the source device 200 might communicate with destination device 202 through several hops. For example, source device 200 might transmit data to device 204. Device 204 might then transmit this data to device 206. Finally, device 206 might transmit this data to destination device 202. In this way source device 200 might communicate with destination device 202. Unlike traditional layer 3 devices, however, a routing protocol that operates at layer 2 might be transparent to the upper layer. Accordingly, in various embodiments, no modifications to the upper layer are required to enable multi-hop communication for WiMedia-based devices.

FIG. 3 is a diagram illustrating an example of one possible perceived topology between a source device 200 and a destination device 202. Because a routing protocol that operates at layer 2 might be transparent to the upper layer at layer 3, devices that are several hops away might appear as “neighbors,” for example, on the same segment or in the same neighborhood. In some embodiments, each device might appear as if it is on the same Ethernet connection with the other device, for example, even devices with which it does not have an actual direct connection.

Bridges or routers might be used to forward data packets using MAC or IP addresses, respectively. Performing routing at the MAC layer using bridges may mean that packets are sent over a spanning tree to avoid looping of packets. Packets sent over a spanning tree might be sent over paths longer than the shortest paths between a pair of devices. Accordingly, the available bandwidth might be underutilized. Furthermore, in an ad hoc network, maintaining a spanning tree might incur excessive overhead depending on mobility. On the other hand, performing routing at layer 3, for example, using the next hop IP address to route the packet, is not transparent to the IP layer. For example, routing at layers might require some changes at layer 3. Changes to the IP protocol might be undesired in many cases because these changes might require upgrading of millions of already existing devices.

In some embodiments, modifications might be introduced, for example, on the Ad hoc On-Demand Distance Vector (“AODV”) routing protocols. The way in which information is exchanged may be revised to take advantage of the information and tools available at layer 2 in order to reduce the overhead needed to exchange routing messages and to choose routes that might offer improved performance under certain circumstances. For example, layer 2 might include information about, detailed channel condition and tools such as a beacon protocol. This may reduce the overhead needed to exchange routing messages. Additionally, this may allow routes to be chosen that might offer increased performance in certain circumstances.

In some embodiments, the modifications might add two fields after the MAC header in a packet. In some embodiments, one field can be a 6-byte field that represents the Extended Unique Identifier (“EUI48”) address of the packet's final destination device. In various embodiments, the other field can be a 6-byte field that represents the Extended Unique Identifier (EUI48) address of the packet's original source device. One of the reserved bits in the MAC header might be used to indicate the existence of the two fields. The two fields might be added in all but the last hop, for example, whenever the recipient of the packet is the final destination. This may reduce the overhead of carrying 12 more bytes and allow multi-hop delivery to devices that are designed without proposed changes in this document (e.g., MAC 1.0 devices.) Although the IEEE 802.11s scheme might use AODV for layer 2 routing, in other embodiments, it might use a different addressing scheme. In various embodiments, an 802.11s device might communicate only with access points. In comparison, in some embodiments, a WiMedia device might communicate with any other device in its neighborhood. In addition, in various embodiments, unlike the 802.11s, the WiMedia device may use 2-byte source and destination address instead of EUI48s in the MAC header.

A device that receives a MAC client's generated packet that is sent to the MAC broadcast address (i.e., BcstAddr) might be required to rebroadcast the received packet. This may be needed, for example, so Internet Protocol (“IP”) Address Resolution Protocol (“APR”) packets can reach any device in the networks. This may hide the physical topology from upper layer, allowing upper layers to behave as if the underlying network is fully connected. For example, the connection may appear to be an Ethernet to the upper layer.

In various embodiments an AODV protocol might be used with some modification to the rules. For example, the AODV protocol used in RFC 3561, Ad hoc On-Demand Distance Vector (“AODV”) Routing might be used in conjunction with the systems and methods described herein. (RFC3561, AODV, is incorporated herein by reference in its entirety.) In some embodiments, source IP addresses may be replaced with source EU148 and every destination IP address with destination EUI48. Additionally, the AODV's hello messages might be eliminated. AODV's hello messages might be eliminated because, in some embodiments, beacons may be used for the same purpose, for example, determining if the a link is alive.

In some embodiments, a device might send routing information in its beacons, if possible, for example, if the maximum length beacon is enough. Otherwise, the device may send that information in a broadcast control packet. In addition to these modifications, in some embodiments, every device may keep a table in its memory in which the device stores the EUI48 of the next hop device for each active route that was discovered through the routing protocol.

In some embodiments, a variant of the above protocol might be used. For example, instead of a routing scheme that uses only MAC layer addresses, the routing scheme might use layer 3 addresses (e.g., IP addresses) in conjunction with MAC layer addresses. In these embodiments, an entry in the table stored at a device may encode the final destination IP address instead of that destination EUI48 and the next hop EUI48. On receiving an Address Resolution Protocol (ARP) packet, the routing protocol at the MAC layer will, in various embodiments, determine from the ARP packet the destination IP address and if the next hop EUI48 exists in its routing table. If it does, then the routing protocol can hand back the next hop EUI48 to the IP layer in a route-reply packet. If the next hop EU148 does not exist in the routing table, the routing protocol may proceed to find a route to the destination. In these embodiments, the IP address of the final destination may be coupled with the EUI48 MAC address of the next hop. This may, however, in some embodiments, require that the layer 2 routing protocol “snoop” into layer 3 packets and look at their layer 3 addressing scheme.

Some embodiments might support end-to-end quality-of-service (QoS). Enabling QoS might require a QoS-enabled routing protocol that is able to find a route with enough resources to support the QoS measures an application requires. These measures include, for example, bandwidth, delay and delay jitter. Additionally, a reservation protocol that, once a route is found, reserves enough resources along the route to support the application QoS requirements may also be required.

In order to enable QoS routing in WiMedia, in some embodiments, the traffic specification (“TSPEC”) parameters might be carried in the route-request. For example, in some embodiments, the TSPEC from the WiNet Protocol Release 0.9, or some other protocol may be used. (The WiNet Protocol Release 0.9 and The WiMedia MAC Protocol Release 1.0 are herein incorporated by reference.) In various embodiments, a device that receives a route-request and cannot support an application requirement specified in the TSPEC should ignore the received route-request. In some embodiments, a result of this may be that devices that might support the application requirement may be the only candidates that relay application traffic.

Another approach is not to include the TSPEC in the route-request. For example, various embodiments may use a device that re-broadcasts a route-request. For example, the route request might include the remaining capacity seen by the device, such as, for example, number of unreserved MASs. This information may then be relayed to the source of the route-requester via the route-reply packet. At that point, the route-requester might determine which route might potentially satisfy its application QoS needs.

In some embodiments, once a route is found, for example, via one of the two approaches mentioned above, a reservation protocol may be useful. In some embodiments, to accomplish this in WiMedia, a reservation-request might be sent through the route found. When the reservation-request is received a device on that route may forward the route reservation-request to the next device in the route only if the resources are still available. Additionally, in some embodiments, the resources might be reserved. Otherwise, a reservation-deny packet may be sent back to the source containing the reasons for the denial. If the target receives a reservation-request, it might send a reservation-confirm to the source confirming that the reservation process is complete. Accordingly, the source might start sending the stream of data. Similar to routing control packets, reservation packets may be included in beacon. The reservation packets may be in the form of an information element (IE), for example, if the maximum length beacon is enough, to contain an IE.

In some embodiments, each MAC may know its own IP address(es) because the IP layer registers IP addresses with the MAC. For example, each device might keep the information of the following table stored in its memory:

TABLE 1

| Node | Next Hop | Seq # | Hop Count |
|---|---|---|---|
| IP(X) | EUI(Y) | . . . | . . . |

In table 1, IP(X) is the IP address for the originator of a message and EUI(Y) is the next hop needed to get to that IP address. Accordingly, in the discussion that follows, IP(S) is the IP address of the source device 200. IP(D) is the IP address of the destination device 202.

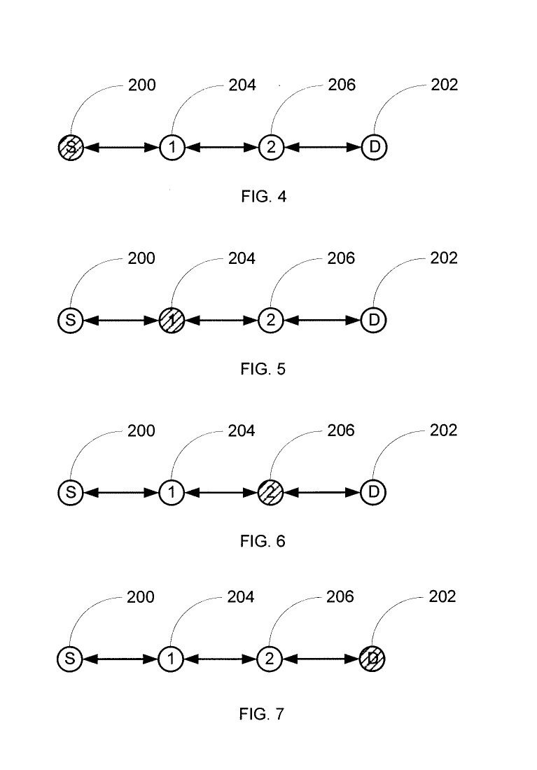

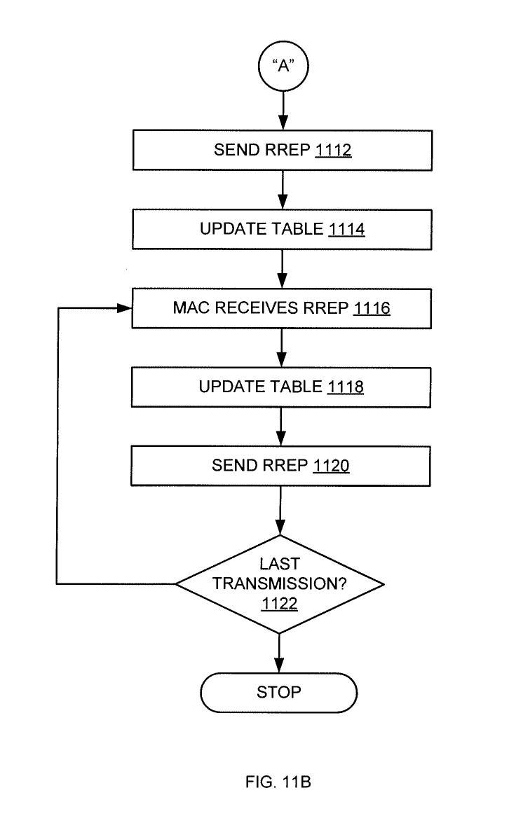

FIGS. 4-10 are diagrams illustrating an example of how a table might be generated and stored in a device's memory. FIG. 11A-B is a flowchart illustrating one example method of building a routing table in accordance with FIGS. 4-10. The diagram of FIGS. 4-10 and the flowchart of FIGS. 11A-B are all discussed by working through an example of generating the tables 1-7 included herein. In various embodiments, this table may be stored in a device's memory. Additionally, as will be understood by those of skill in the art, interim data calculated in conjunction with the generation of the table might also be stored in the device. In FIG. 4, at source device 200, the MAC receives an ARP with the IP address of the destination device 202, IP(D), from the IP layer. This is further illustrated by a step 1100 of FIG. 11A. In a step 1102, the MAC includes a route-request (“RREQ”) with IP(D) and IP(S) in its beacons. In this way, source device 200 may transmit its RREQ to other network devices.

In FIG. 5, at device 204, the MAC receives a RREQ in the source device's 200 beacon. This is further illustrated by a step 1104 in FIG. 11A. In a step 1106, the MAC compares IP(D) with its IP address. Accordingly, device 204 may determine if it is the destination device. In a step 1108, the IP(D) does not match the IP address of device 204. This indicates that device 204 is not the destination device for this particular request. Accordingly, device 204 rebroadcasts RREQ in its beacons and updates its table with a route to source device 200 as illustrated in a step 1110.

TABLE 2

| Node | Next Hop | Seq # | Hop Count |
|---|---|---|---|
| IP(S) | EUI(S) | . . . | . . . |

Table 2 is a table for device 204. In table 2, IP(S) is the IP address for the source device 200 and EUI(S) is the next hop needed to get to that IP address. In this case device 204 might get to source device 200 directly, but it probably cannot get to the destination device 202 directly.

In FIG. 6 at device 206 the MAC receives a RREQ in device's 204 beacon. This is further illustrated by step 1104 in FIG. 11A. In a step 1106, the MAC compares IP(D) with its IP. Accordingly, device 206 may determine if it is the destination device. In step 1108, the IP(D) does not match the IP of device 206. This indicates that device 206 is not the destination device for this particular request. Accordingly, device 206 rebroadcasts RREQ in its beacons and updates its table with a route to source device 200 as illustrated in a step 1110.

TABLE 3

| Node | Next Hop | Seq # | Hop Count |
|---|---|---|---|
| IP(S) | EUI(1) | . . . | . . . |

Table 3 is a table for device 206. In table 3 IP(S) is the IP address for the source device 200 and EUI(1) is the next hop needed to get to that IP address. In this case device 206 probably cannot get to source device 200 directly. Device 206 will need to transmit to device 204. Device 206, however, may be able to get to the destination device 202 directly.

In FIG. 7, at destination device 202, the MAC receives a RREQ in device's 206 beacon This is illustrated by step 1104 in FIG. 11A. In step 1106 the MAC compares IP(D) with its IP to determine if it is the destination device for the request. In step 1108 the IP(D) matches the IP address of destination device 202. This indicates that device 202 is the destination device for that RREQ. Accordingly, destination device 202 sends a route-reply (“RREP”) in its beacon that includes IP(D) in a step 1112 of FIG. 11B, to IP(S), the source device 200 IP address. Additionally, device 202 may update its table with a route to source device 200 as illustrated in a step 1114.

TABLE 4

| Node | Next Hop | Seq # | Hop Count |
|---|---|---|---|
| IP(S) | EUI(2) | . . . | . . . |

Table 4 is a table for destination device 202. In table 4 IP(S) is the IP address for the source device 200 and EUI(2) is the next hop needed to get to that IP address. In this case destination device 202 probably cannot get to source device 200 directly. Destination device 202 probably will need to transmit to device 206.

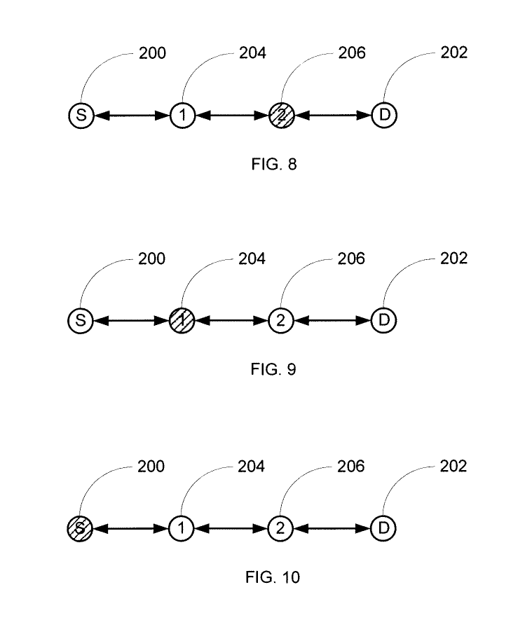

In FIG. 8 at device 206 the MAC receives a RREP in the destination device's 202 beacon. This is illustrated by a step 1116. The MAC may update its table in a step 1118 and send the RREP in its beacon as illustrated in a step 1122.

TABLE 5

| Node | Next Hop | Seq # | Hop Count |
|---|---|---|---|
| IP(S) | EUI(1) | . . . | . . . |
| IP(D) | EUI(D) | | |

Table 5 is a table for device 206. In table 5 IP(S) is the IP address for the source device 200 and EUI(1) is the next hop needed to get to that IP address. IP(D) is the IP address for the destination device 202 and EUI(D) is the next hop needed to get to that IP address.

In FIG. 9 at device 204 the MAC receives a RREP in the device's 206 beacon. This is illustrated by step 1116 in FIG. 11B. The MAC updates its table in step 1118 and sends the RREP in its beacon as illustrated in step 1122.

TABLE 6

| Node | Next Hop | Seq # | Hop Count |
|---|---|---|---|
| IP(S) | EUI(S) | . . . | . . . |
| IP(D) | EUI(2) | | |

Table 6 is a table for device 204. In table 6, IP(S) is the IP address for the source device 200 and EUI(S) is the next hop needed to get to that IP address. IP(D) is the IP address for the destination device 202 and EUI(2) is the next hop needed to get to that IP address.

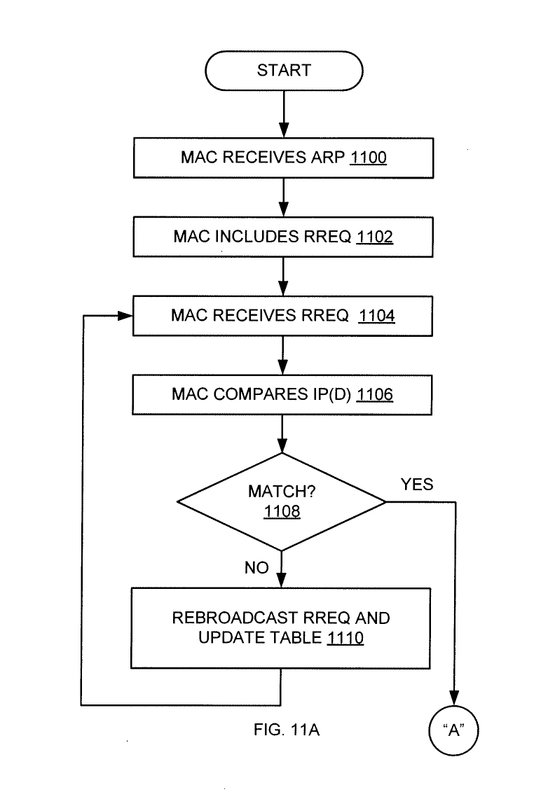

In FIG. 10 at source device 200 the MAC receives a RREP in the device's 204 beacon. This is illustrated by step 1116. The MAC updates its table in step 1118 and sends the RREP in its beacon as illustrated in step 1122.

TABLE 7

| Node | Next Hop | Seq # | Hop Count |
|---|---|---|---|
| IP(S) | EUI(S) | . . . | . . . |

Table 7 is a table for source device 200 (device “S”). In table 7 IP(S) is the IP address for the source device 200 and EUI(1) is the next hop needed to get to that IP address.

After the last transmission, as illustrated in step 1122, the process completes. It will be understood that the process might be used additional times to establish new routes, to update routes to devices as devices locations change, etc.

The systems and methods described herein might be implemented using a computer. In some embodiments the computer might be a desktop, laptop, or notebook computer. In other embodiments, the computer might be a mainframe, supercomputer or workstation. In yet other embodiments, the computer might be a hand-held computing device such as a PDA, smart phone, cell phone, palmtop, etc. The computer might also represent computing capabilities embedded within or otherwise available to a given device.

The computer might include one or more processors, which may be microprocessors, microcontrollers, or other control logic and memory, such as random access memory (“RAM”), read only memory (“ROM”) or other storage device for storing information and instructions for the processor. Other information storage mechanisms might also be connected to the computer, such as a hard disk drive, a floppy disk drive, a magnetic tape drive, an optical disk drive, a CD or DVD drive (R or RW), or other removable or fixed media drive, such as a program cartridge and cartridge interface, a removable memory (for example, a flash memory or other removable memory module) and memory slot, a PCMCIA slot and card, and other fixed or removable storage units and interfaces that allow software and data to be transferred from the storage unit to the computer.

The computer might also include a communications interface that may be used to allow software and data to be transferred between the computer and clients. Examples of the communications interface might include a modem or softmodem, a network interface (such as an Ethernet, network interface card, or other interface), a communications port (such as for example, a USB port, IR port, RS232 port or other port), or other wired or wireless communications interface. Software and data transferred via the communications interface are carried on signals, which might be electronic, electromagnetic, optical or other signals capable of being received by a given communications interface. The signals might be provided to the communications interface using a wired or wireless medium. Some examples of a channel might include a phone line, a cellular phone link, an RF link, an optical link, a network interface, a local or wide area network, the internet, and other communications channels.

In this document, the terms “computer program medium” and “computer usable medium” are used to generally refer to media such as, for example, the memory, storage unit, media, and signals on a channel. These and other various forms of computer usable media might be involved in carrying one or more sequences of one or more instructions to the processor for execution. Such instructions, generally referred to as “computer program code” (which might be grouped in the form of computer programs or other groupings), when executed, enable the computer to perform features or functions of the present invention as discussed herein.

While various embodiments of the present invention have been described above, it should be understood that they have been presented by way of example only, and not of limitation. Likewise, the various diagrams might depict an example architectural or other configuration for the invention, which is done to aid in understanding the features and functionality that might be included in the invention. The invention is not restricted to the illustrated example architectures or configurations, but the desired features might be implemented using a variety of alternative architectures and configurations. Indeed, it will be apparent to one of skill in the art how alternative functional, logical or physical partitioning and configurations might be implemented to implement the desired features of the present invention. Also, a multitude of different constituent module names other than those depicted herein might be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more,” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention might be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases might be absent. The use of the term “module” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

1. A method of building a routing table comprising:
receiving an address resolution protocol packet at the Medium Access Control layer;
transmitting a route-request in a device's beacon; and
receiving a routing-reply at the Medium Access Control layer based on the results of the compare.

2. The method of claim 1, further comprising transmitting an Extended Unique Identifier address of the routing request's final destination device.

3. The method of claim 1, further comprising transmitting an Extended Unique Identifier address of the routing request's original source device.

4. The method of claim 1, further comprising transmitting a source address.

5. The method of claim 1, further comprising transmitting a destination address.

6. A method of building a routing table comprising:
receiving an address resolution protocol packet at a first device at the Medium Access Control layer;
transmitting a route-request in the device's beacon;
receiving the route-request at a second device at the Medium Access Control layer; and
comparing the route-request.

7. The method of claim 6, further comprising rebroadcast the route-request based on the results of the compare.

8. The method of claim 6, further comprising updating the routing table based on the results of the compare.

9. The method of claim 6, further comprising sending a routing-reply based on the results of the compare.

10. The method of claim 6, further comprising updating the routing table based on the results of the compare.

11. The method of claim 6, further comprising receiving a routing-reply based on the results of the compare.

12. A networking device comprising:
a memory configured to store instructions;
a processor, coupled to memory and configured to execute the instructions to cause the device to:
receive an address resolution protocol packet at the Medium Access Control layer;
transmit a route-request in the device's beacon; and
receive a routing-reply at the Medium Access Control layer based on the results of the compare.

13. The device of claim 12, wherein the memory stores an instruction causing the device to transmit an Extended Unique Identifier address of the routing request's final destination device in the beacon.

14. The device of claim 12, wherein the memory stores an instruction causing the device to transmit an Extended Unique Identifier address of the routing request's original source device in the beacon.

15. The device of claim 12, wherein the memory stores an instruction causing the device to transmit a source address and a destination address.

16. The device of claim 12, wherein the device is further configured to receive a request transmitted in another device's beacon.

17. The device of claim 12, wherein the device is further configured to compare a request received in another device's beacon.

18. The device of claim 12, wherein the device is further configured to rebroadcast a request transmitted in another device's beacon based on a compare.

19. The device of claim 12, wherein the device is further configured to update the table based on a compare and a received request transmitted in another device's beacon.

20. The device of claim 12, wherein the device is further configured to transmit a route-reply based on a request received from another device's beacon.
